(19) United States
(12) Patent Application Publication
(10) Pub. No.: US 2024/0047888 A1
(43) Pub. Date: Feb. 8, 2024

(54) RADIO FREQUENCY CIRCULATOR

(71) Applicant: Molex, LLC, Lisle, IL (US)

(72) Inventors: Andrey Taykov, Quebec (CA); Nikolay Volobuev, Montreal (CA)

(21) Appl. No.: 18/224,597

(22) Filed: Jul. 21, 2023

Related U.S. Application Data
(60) Provisional application No. 63/394,827, filed on Aug. 3, 2022.

(51) Int. Cl. H01Q 13/10; H01P 5/18

(52) U.S. Cl. CPC H01Q 13/106; H01P 5/184

(57) ABSTRACT

Radio frequency circulators are provided. In one implementation, a radio frequency circulator includes a substrate. The substrate includes a magnetizable material. The substrate has a first surface and a second surface. The second surface opposes the first surface. The radio frequency circulator includes a patterned conductive layer disposed on the first surface of the substrate. The patterned conductive layer includes a plurality of ports coupled to a resonator structure. The resonator structure includes a plurality of peripheral extensions coupled to a microstrip junction. Each peripheral extension includes a plurality of open microstrip stubs and at least one channel connecting the plurality of open microstrip stubs. The plurality of peripheral extensions are arranged about the microstrip junction.

### RELATED APPLICATION

The present application claims priority to U.S. Provisional Patent Application No. 63/394,827, filed on Aug. 3, 2022, which is incorporated by reference in its entirety.

### FIELD

The present disclosure relates generally to radio frequency circulators.

### BACKGROUND

Radio frequency circulators can be used for a variety of applications. For instance, radio frequency circulators can be used in conjunction with the protection of amplifiers used in the distribution of microwave signals. Radio frequency circulators have been used in conjunction with communication of signals in cellular networks, such as in cellular base stations used to communicate signals under a 3G, 4G, 5G or other communication protocol.

### SUMMARY

Aspects and advantages of embodiments of the present disclosure will be set forth in part in the following description, or may be learned from the description, or may be learned through practice of the embodiments.

An example aspect of the present disclosure is directed to a radio frequency circulator. In one example implementation, the radio frequency circulator includes a substrate. The substrate includes a magnetizable material. The substrate has a first surface and a second surface. The second surface opposes the first surface. The radio frequency circulator includes a patterned conductive layer disposed on the first surface of the substrate. The patterned conductive layer includes a plurality of ports coupled to a resonator structure. The resonator structure includes a plurality of peripheral extensions coupled to a microstrip junction. Each peripheral extension includes a plurality of open microstrip stubs and at least one channel connecting the plurality of open microstrip stubs. The plurality of peripheral extensions are arranged about the microstrip junction.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a perspective view of a radio frequency circulator according to example embodiments of the present disclosure;

FIG. 2 depicts a surface of a substrate of a radio frequency circulator according to example embodiments of the present disclosure;

FIG. 3 depicts a surface of a substrate of a radio frequency circulator according to example embodiments of the present disclosure;

FIG. 4 depicts an example peripheral extension of a resonator structure to be used in a radio frequency circulator according to example embodiments of the present disclosure;

FIG. 5 depicts a magnified example of a peripheral extension of a resonator structure to be used in a radio frequency circulator according to example embodiments of the present disclosure;

FIG. 6 depicts an example S-parameter plot for a radio frequency circulator according to example embodiments of the present disclosure; and

FIG. 7 depicts a schematic of an example radio frequency communication device incorporating a radio frequency circulator according to example embodiments of the present disclosure.

### DETAILED DESCRIPTION OF THE PREFERRED EMBODIMENTS

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example embodiments of the present disclosure are directed to a radio frequency circulator. Radio frequency circulators using a substrate of magnetizable material can be used, for instance, with radio frequency communication systems. Improvements in telecommunication systems have led to an increased demand for a larger quantity of radio frequency circulators to be used, for instance, in electronic devices, such as cellular base stations. For instance, with the recent advancement of 5G cellular systems, a cellular base station may need to include a high number of radio frequency circulators, such as 64 radio frequency circulators or more, such as 128 radio frequency circulators or more. To meet these requirements, it can be advantageous to reduce the not only the size of the radio frequency circulators but also to reduce the cost used in materials to manufacture the radio frequency circulators and/or to use more efficient manufacturing processes.

A radio frequency circulator can include a substrate of magnetizable material (e.g., a ferrite material). The substrate can have a first surface and a second surface opposing the first surface. The radio frequency circulator can include a patterned conductive layer (e.g., microstrip layer) on the first surface. The radio frequency circulator can include a ground plane disposed on the second surface. A permanent magnet can be mounted to the first surface on top of the patterned conductive layer. The patterned conductive layer can form a resonator structure with a plurality of ports (e.g., three ports).

According to example aspects of the present disclosure, the resonator structure can include a plurality of peripheral extensions coupled to a microstrip junction. Each peripheral extension can include a plurality of open microstrip stubs and at least one channel connecting the plurality of microstrip stubs. The plurality of peripheral extensions can be arranged about the microstrip junction on the first surface of the substrate.

More particularly, each peripheral extension of the resonator structure can include a plurality of parallel open stubs. The open stubs can be connected by a channel. The channel can have a width that is smaller than a width of each open stub. In some embodiments, the resonator structure includes a plurality of peripheral extensions arranged at regular intervals about the substrate. For instance, the resonator structure can include three peripheral extensions arranged at regular intervals at an angular spacing of about 120° around a triangle-shaped Y-junction. As used herein, the use of the term “about” in conjunction with a numerical value refers to within 15% of the stated numerical value

For instance, the microstrip junction can define an axis of symmetry between two of the plurality of ports. Each peripheral extension of the resonator structure can include a plurality of open microstrip stubs extending generally perpendicular to the axis of symmetry. As used herein, the term “generally perpendicular” refers to within 15° of perpendicular and includes perpendicular. In some embodiments, the plurality of open microstrip stubs can include a plurality of first open microstrip stubs that are parallel with one another and extend in a first direction that is generally perpendicular to the axis of symmetry. The plurality of open microstrip stubs can include a plurality of second open microstrip stubs that are parallel with one another and extend in a second direction that is generally perpendicular to the axis of symmetry. The second direction can be opposite to the first direction.

In one example implementation, a radio-frequency circulator can be a three-port radio frequency circulator. The three-point radio frequency circulator can include a substrate having a ferrite material. The substrate can have a first surface and a second surface. The radio frequency circulator can include a patterned conductive layer disposed on the first surface. The radio frequency circulator can include a ground plane disposed on the second surface. The patterned conductive layer can include a first port, a second, port, and a third port. The patterned conductive layer can include a resonator structure.

The resonator structure can include a triangle-shaped Y-junction coupled to the first port, the second port and the third port. The resonator structure can include a first peripheral extension, a second peripheral extension, and a third peripheral extension. The first peripheral extension can include a plurality of open microstrip stubs and at least one channel connecting the plurality of open microstrip stubs. Each of the plurality of open microstrip stubs can extend generally perpendicular to a first axis of symmetry defined between the first port and the second port. The second peripheral extension can include a plurality of open microstrip stubs and at least one channel connecting the plurality of open microstrip stubs. Each of the plurality of open microstrip stubs can extend generally perpendicular to a second axis of symmetry defined between the second port and the third port. The third peripheral extension can include a plurality of open microstrip stubs and at least one channel connecting the plurality of open microstrip stubs. Each of the plurality of open microstrip stubs can extend generally perpendicular to a third axis of symmetry defined between the third port and the first port.

The patterned conductive layer can include a first microstrip line extending from the first port to the triangle-shaped Y-junction. The patterned conductive layer can include a second microstrip line extending from the second port to the triangle-shaped Y-junction. The patterned conductive layer can include a third microstrip line extending from the third port to the triangle-shaped Y-junction. The radio frequency circulator can include a permanent magnet mounted to the first surface of the substrate such that a center of the permanent magnet is disposed over the triangle-shaped Y-junction.

Aspects of the present disclosure can provide numerous technical effects and benefits. For instance, the configuration of the peripheral extensions of the resonator structure according to example aspects of the present disclosure can provide for a significant reduction in size of the radio frequency circulator, such as a reduction in size of about 50% or more, without degradation of electrical performance of the radio frequency circulator. This can reduce the size of the required substrate (e.g., ferrite substrate) for the circulator and can reduce the size of other components needed to manufacture the substrate. The reduced size of the substrate can provide for use of batch manufacturing methods to manufacture the radio frequency circulator. The small size and batch manufacturing can significantly reduce material costs and labor costs for manufacturing the radio frequency circulator.

With reference now to the Figures, example embodiments of the present disclosure will now be set forth.

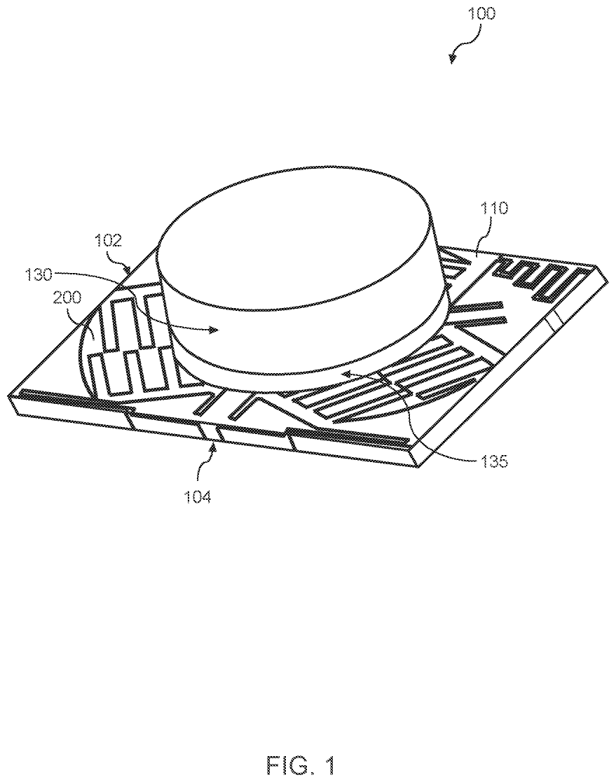

FIG. 1 depicts a radio frequency circulator 100 according to example aspects of the present disclosure. The radio frequency circulator 100 of FIG. 1 is a microwave circulator intended for use in microwave frequency applications (e.g., 1 GHz to 1000 GHz). Those of ordinary skill in the art, using the disclosures provided herein, will understand that the radio frequency circulator 100 of FIG. 1 can be used at other frequencies without deviating from the scope of the present disclosure.

The radio frequency circulator 100 includes a substrate 110. The substrate 110 can include or can be formed from a magnetizable material. A magnetizable material is any material where application of a magnetic field causes the material itself to become a source of a magnetic field. A magnetizable material may have a relative magnetic permeability (permeability relative to free space) of 10 or greater, such as 100 or greater.

In particular embodiments, the magnetizable material is ferrite. The example radio frequency circulator 100 will be discussed with reference to a substrate 110 of ferrite material for purposes of illustration and discussion. Those of ordinary skill in the art, using the disclosures provided herein, will understand that other magnetizable materials can be used without deviating from the scope of the present disclosure.

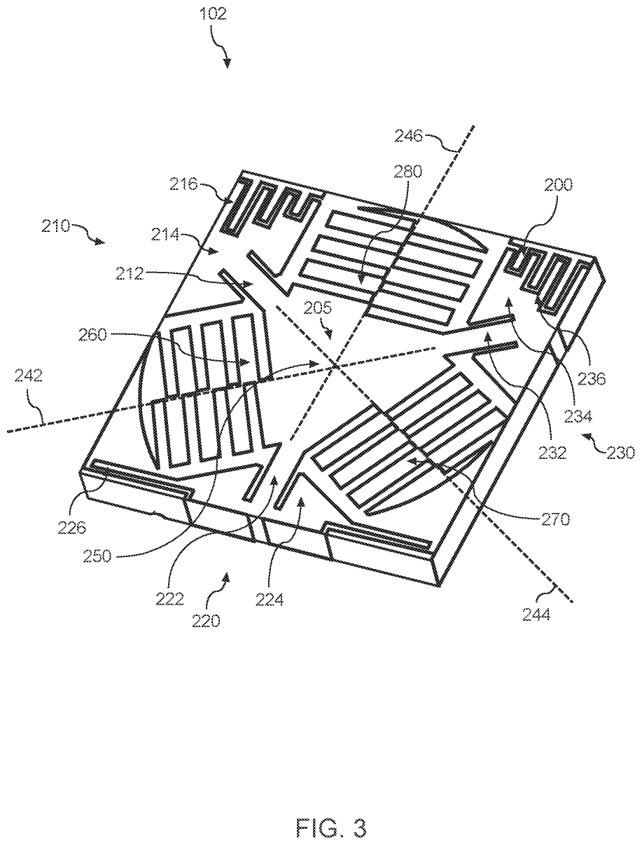

The substrate 110 of ferrite material can include a first surface 102 and an opposing second surface 104. The first layer can have a patterned conductive layer 200 formed on the first surface 102 of the substrate 110 of ferrite material. The patterned conductive layer 200 can be formed on the first surface 102 of the substrate 110 of ferrite material using a physical vapor deposition process or other suitable process. The patterned conductive layer 200 can be any suitable conductor exhibiting electrically conductive properties. For instance, the patterned conductive layer 200 can be copper, silver, or other suitable conductor. Details concerning the conductive layer 200 will be discussed with reference to FIGS. 3-5.

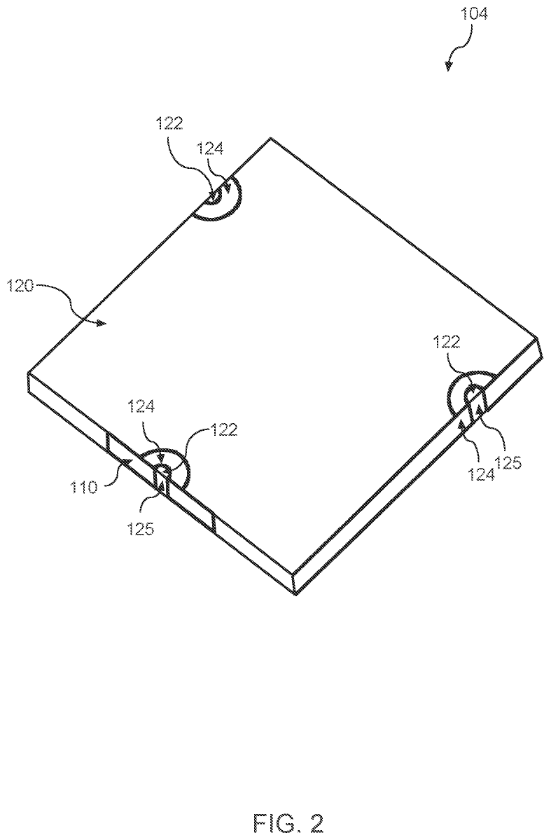

Referring to FIG. 1, a ground plane (not shown in FIG. 1) can be formed on the second surface 104 of the radio frequency circulator 100. Details concerning the ground plane will be discussed with reference to FIG. 2.

A permanent magnet 130 can be mounted to the first surface 102 of the substrate 110 of ferrite material. The permanent magnet 130 can have a cylindrical shape. Other suitable shapes of the permanent magnet 130 can be used without deviating from the scope of the present disclosure. The permanent magnet 130 can be any material that creates its own persistent magnetic field. The permanent magnet 130 can be mounted concentrically and/or coaxially relative to the patterned conductive layer 200 such that a center of the permanent magnet 130 is aligned with a geometric center of the substrate 110 and/or the patterned conductive layer 200. The permanent magnet 130 can make the radio frequency circulator 100 functional as a non-reciprocal component by applying a magnetic bias to the substrate 110 of ferrite material.

A dielectric spacer 135 can be disposed between the permanent magnet 130 and the patterned conductive layer 200. The dielectric spacer 135 can be formed from any suitable dielectric material. The dielectric spacer 135 can reduce the interference by the permanent magnet 130 of the electromagnetic field in the substrate 110 of ferrite material and in the patterned conductive layer 200.

FIG. 2 depicts the second surface 104 of the substrate 110 of ferrite material according to example embodiments of the present disclosure. A ground plane 120 of conductive material is disposed on the second surface 104 of the substrate 110. The ground plane 120 can be any suitable conductor exhibiting electrically conductive properties. For instance, the ground plane 120 can be copper, silver, or other suitable conductor. The ground plane 120 can be formed on the second surface 104 of the substrate 110 of ferrite material using a physical vapor deposition process or other suitable process. The ground plane 120 can be disposed over a substantial portion of the second surface 104 of the substrate 110, such as 75% of the second surface 104 of the substrate 110, such as 80% of the second surface 104 of the substrate 110, such as 90% of the second surface 104 of the substrate 110, such as 100% of the second surface 104 of the substrate 110.

As shown in FIG. 2, the second surface 104 of the substrate 110 of ferrite material can include three soldering pads 122. Each soldering pad 122 can be associated with one of a first port, a second port, or a third port of the radio frequency circulator 100. Each soldering pad 122 can have a semi-circular shape. Other suitable shapes of the soldering pads 122 can be used without deviating from the scope of the present disclosure. Each soldering pad 122 can be used to surface mount the radio frequency circulator 100 to, for instance, a printed circuit board or other board.

Referring to FIG. 2, each soldering pad 122 is separated from the ground plane 120 by a slot 124. The slot(s) 124 can be semicircular slots. The soldering pads 122 can be connected to a corresponding port on the patterned conductive layer 200 on the first surface of the substrate by a conductive line 125 deposited on a side of the substrate 110 of ferrite material. Alternatively, the soldering pads 122 can be connected to a corresponding port on the patterned conductive layer 200 using vias or through-holes with conductive walls.

Example aspects of the present disclosure are discussed with reference to a radio frequency circulator 100 having soldering pads 122 for surface mounting to a circuit board for purposes of illustration and discussion. Those of ordinary skill in the art, using the disclosures provided herein, will understand that other suitable surface mount technology can be used without deviating from the scope of the present disclosure.

FIG. 3 depicts the patterned conductive layer 200 disposed on the first surface 102 of the substrate 110 of ferrite material according to example embodiments of the present disclosure. The patterned conductive layer 200 has three ports: a first port 210, a second port 220, and a third port 230. The first port 210, the second port 220, and third port 230 can be arranged at regular intervals about a resonator structure 205. More particularly, the first port 210, the second port 220, and the third port 230 can be arranged at an angular spacing of about 120° relative to one another about the resonator structure 205.

The resonator structure 205 can include a microstrip junction—in this example a triangle-shaped Y-junction 250—and a plurality of peripheral extensions 260, 270, and 280. The triangle-shaped Y-junction 250 has 120° symmetry with a triangle shape. For three-port devices, other suitable shapes having a 120° symmetry can be used without deviating from the scope of the present disclosure. The triangle-shaped Y-junction 250 can define a first axis of symmetry 242 between the first port 210 and the second port 220. The triangle-shaped Y-junction 250 can define a second axis of symmetry 244 between the second port 220 and the third port 230. The triangle-shaped Y-junction 250 can define a third axis of symmetry 246 between the third port 230 and the first port 210.

Aspects of the present disclosure are discussed with reference to a three-port radio frequency circulator. Those of ordinary skill in the art, using the disclosures provided herein, will understand that the radio frequency circulator can have more ports without deviating from the scope of the present disclosure. For instance, the radio frequency circulator can be a four-port radio frequency circulator having ports arranged at regular intervals with an angular spacing of about 90° relative to one another about a resonator structure.

Referring to FIG. 3, the patterned conductive layer 200 can include a first microstrip line 212 extending from the first port 210 to the triangle-shaped Y-junction 250. The patterned conductive layer 200 can include a second microstrip line 222 extending from the second port 220 to the triangle-shaped Y-junction 250. The patterned conductive layer 200 can include a third microstrip line 232 extending from the third port 230 to the triangle-shaped Y-junction 250.

The patterned conductive layer 200 can include one or more open capacitive stubs 214 at the end of the first microstrip line 212. The patterned conductive layer 200 can include one or more additional slot capacitances 216 at the end of the first microstrip line 212. The one or more open capacitive stubs 214 and/or the additional slot capacitances 216 along with the first microstrip line 212 can provide a matching circuit for the first port 210.

The patterned conductive layer 200 can include one or more open capacitive stubs 224 at the end of the second microstrip line 222. The patterned conductive layer 200 can include one or more additional slot capacitances 226 at the end of the second microstrip line 222. The one or more open capacitive stubs 224 and/or the additional slot capacitances 226 along with the second microstrip line 222 can provide a matching circuit or the second port 220.

The patterned conductive layer 200 can include one or more open capacitive stubs 234 at the end of the third microstrip line 232. The patterned conductive layer 200 can include one or more additional slot capacitances 236 at the end of the third microstrip line 232. The one or more open capacitive stubs 234 and/or the additional slot capacitances 236 along with the third microstrip line 232 can provide a matching circuit or the third port 230.

According to example embodiments of the present disclosure, the resonator structure 205 can include a plurality of peripheral extensions coupled to the triangle-shaped Y-junction 250. More particularly, the resonator structure 205 includes a first peripheral extension 260 arranged between the first port 210 and the second port 220. The resonator structure 205 includes a second peripheral extension 270 arranged between the second port 220 and the third port 230. The resonator structure 205 includes a third peripheral extension 280 arranged between the third port 230 and the first port 210. As illustrated in FIG. 3, the three r peripheral extensions 260, 270, and 280 are arranged at regular intervals at an angular spacing of about 120° around the triangle-shaped Y-junction 250.

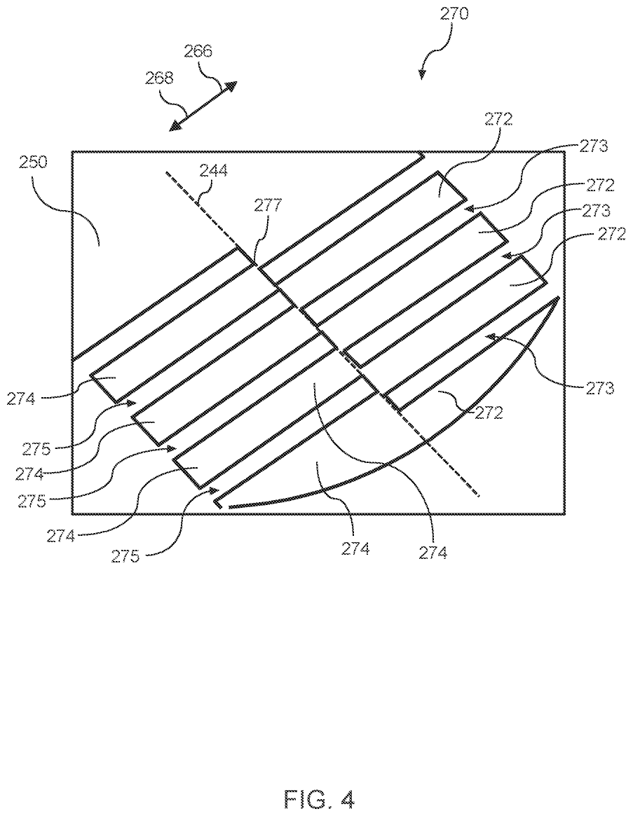

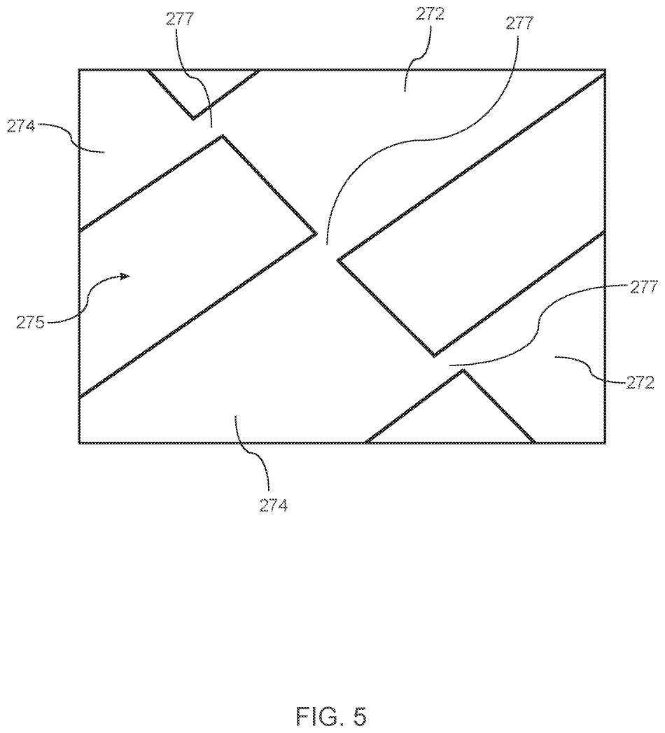

As will be discussed in more detail with reference to FIGS. 4 and 5, each of the three peripheral extensions 260, 270, and 280 includes a plurality of open microstrip stubs that extend generally perpendicular to an axis of symmetry defined by the triangle-shaped Y-junction 250. For instance, the first peripheral extension 260 includes a plurality of open microstrip stubs extending generally perpendicular to the first axis of symmetry 242. The second peripheral extension 270 includes a plurality of open microstrip stubs extending generally perpendicular to the second axis of symmetry 244. The third peripheral extension 280 includes a plurality of open microstrip stubs extending generally perpendicular to the third axis of symmetry 246.

FIG. 4 depicts a close-up view of the second peripheral extension 270 according to example embodiments of the present disclosure. FIGS. 4 and 5 depict details of the second peripheral extension 270 for purposes of illustration and discussion. The first peripheral extension 260 and the third peripheral extension 280 can have a similar configuration of open microstrip stubs and channels as the second peripheral extension 270.

The second peripheral extension 270 includes a plurality of first open microstrip stubs 272 extending in a first direction 266. The first direction 266 is generally perpendicular to the second axis of symmetry 244 defined by the triangle-shaped Y-junction 250.

Each of the plurality of first open microstrip stubs 272 can have the same shape (e.g., a rectangular shape) and/or can have different shapes. For instance, as illustrated in FIG. 4, three of the plurality of first open microstrip stubs 272 closest to the triangle-shaped Y-junction 250 can have a rectangular shape. A fourth open microstrip stub of the plurality of first open microstrip stubs 272 can have an arcuate shape. In some embodiments, the open microstrip stub located furthest from the triangle-shaped Y-junction 250 can have an arcuate shape while all other of the plurality of first open microstrip stubs 272 of the resonator structure 270 can have a rectangular shape.

Each of the plurality of first open microstrip stubs 272 can be separated from one another by a slot 273. In some embodiments, a width of the slot(s) 273 can be less than a width of each of the plurality of first open microstrip stubs 272. However, those of ordinary skill in the art, using the disclosures provided herein, will understand that in some embodiments, the slot(s) 273 can have a greater width than the first open microstrip stubs 272 depending on the desired electrical performance of the radio frequency circulator 100.

The second resonator structure 270 includes a plurality of second open microstrip stubs 274 extending in a second direction 268. The second direction 268 is generally perpendicular to the second axis of symmetry 244 defined by the triangle-shaped Y-junction 250. The second direction 268 can be opposite to the first direction 266.

Each of the plurality of second open microstrip stubs 274 can have the same shape (e.g., a rectangular shape) and/or can have different shapes. For instance, as illustrated in FIG. 4, three of the plurality of second open microstrip stubs 274 closest to the triangle-shaped Y-junction 250 can have a rectangular shape. A fourth open microstrip stub of the plurality of second open microstrip stubs 274 can have an arcuate shape. In some embodiments, the open microstrip stub located furthest from the triangle-shaped Y-junction 250 can have an arcuate shape while all other of the plurality of second open microstrip stubs 274 of the resonator structure 270 can have a rectangular shape.

Each of the plurality of second open microstrip stubs 274 can be separated from one another by a slot 275. In some embodiments, a width of the slot(s) 275 can be less than a width of each of the plurality of second open microstrip stubs 274. However, those of ordinary skill in the art, using the disclosures provided herein, will understand that in some embodiments, the slot(s) 275 can have a greater width than the second open microstrip stubs 274 depending on the desired electrical performance of the radio frequency circulator 100.

In some embodiments, each of the plurality of first open microstrip stubs 272 can be disposed opposite at least a portion of a slot 275 separating two of the plurality of second open microstrip stubs 274. Each of the plurality of second open microstrip stubs 274 can be disposed opposite at least a portion of a slot 273 separating two of the plurality of first open microstrip stubs 272. A channel 277 can be used to connect a first open microstrip stub 272 with a second open microstrip stub 274.

FIG. 5 depicts a close-up view of the channels 277 connecting first open microstrip stubs 272 with second open microstrip stubs 274. As shown, each channel 277 has a width that is less than a width of the first open microstrip stubs 272 and the second open microstrip stubs 272, such as at least 5 times less, such as at least 10 times less. However, those of ordinary skill in the art, using the disclosures provided herein, will understand that in some embodiments, the channels 277 can have a greater width than the first open microstrip stubs 272 and the second open microstrip stubs 274 depending on the desired electrical performance of the radio frequency circulator 100.

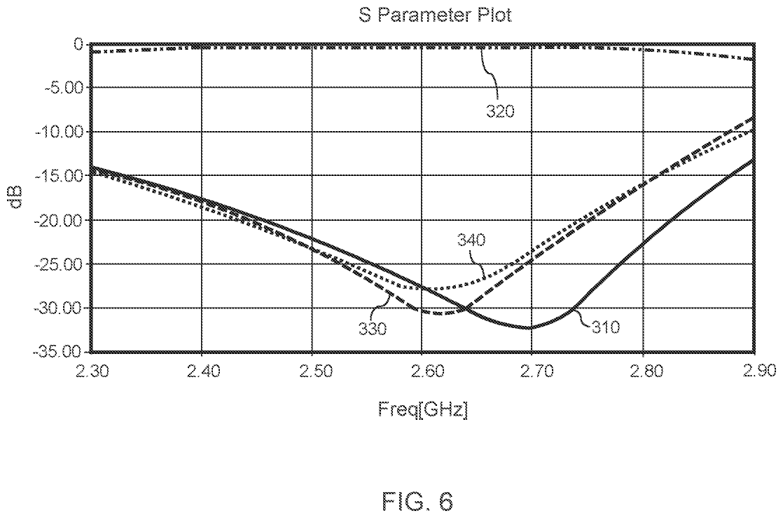

FIG. 6 depicts simulated S-parameters associated with a radio frequency circulator 100 according to example embodiments of the present disclosure. FIG. 6 plots frequency in GHz along the horizontal axis. FIG. 6 plots a value of performance metric (in dB) along the vertical axis. Curve 310 depicts S11 parameters associated with the first port 210 of the radio frequency circulator 100. Curve 320 depicts S21 parameters associated with the second port 220 and the first port 210 of the radio frequency circulator 100. Curve 330 depicts S22 parameters associated with the second port 220 of the radio frequency circulator 100. Curve 340 depicts S33 parameters associated with the third port of the radio frequency circulator 100.

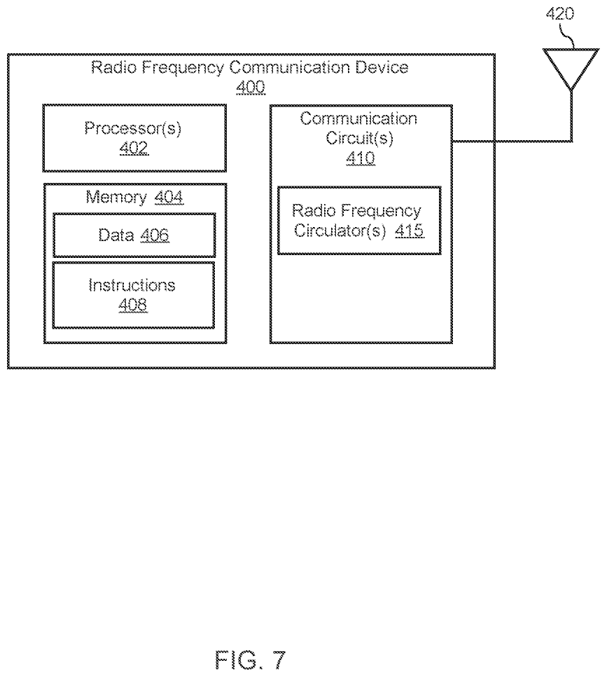

FIG. 7 depicts a schematic of an example radio frequency communication device 400, such as a cellular base station, that incorporates a radio frequency circulator according to example embodiments of the present disclosure. Those of ordinary skill in the art, using the disclosures provided herein, will understand that radio frequency circulators according to example embodiments of the present disclosure can be used in a variety of different types of radio frequency communication devices, such as microwave frequency communication devices.

More particularly, the radio frequency communication device 400 can include one or more processors 402 and one or more memory devices 404. The one or more processors 402 can be any suitable processing device, including, but not limited to, one or more microprocessors, microcontrollers, integrated circuits, logic devices or other suitable processing device(s). The one or more memory devices 404 can be any suitable memory device, including, but not limited to, non-transitory computer-readable media, RAM, ROM, hard drives, flash drives, or other memory devices. The one or more memory devices 404 can store data 406 and computer-readable instructions 408. The computer-readable instructions 408 when executed by the one or more processors 402 can the cause the one or more processors 402 to perform operations. The computer-readable instructions 408 can be implemented as software, hardware, and/or a combination of software and hardware. When implemented as software, the computer-readable instructions 408 can be in any suitable language.

The radio frequency communication device 400 can include one or more communication circuit(s) 410 to facilitate communication of radio frequency signals (e.g., microwave signals) by an antenna 420. The communication circuit(s) 410 can include one or more receivers, transmitters, transceivers, front end modules, base band circuits, matching circuits, tuning circuits, control circuits, transmission lines, or other elements to facilitate communication of radiofrequency signals. The communication circuit(s) 410 can include one or more radio frequency circulators 415 according to example embodiments of the present disclosure. For instance, the one or more radio frequency circulators 415 can each be the radio frequency circulator 100 discussed with reference to FIGS. 1-5.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A radio frequency circulator, comprising:
a substrate, the substrate comprising a magnetizable material, the substrate having a first surface and a second surface, the second surface opposing the first surface; and
a patterned conductive layer disposed on the first surface of the substrate, the patterned conductive layer comprising a plurality of ports coupled to a resonator structure, the resonator structure comprising: a plurality of peripheral extensions coupled to a microstrip junction, each peripheral extension comprising a plurality of open microstrip stubs and at least one channel connecting the plurality of open microstrip stubs, the plurality of peripheral extensions arranged about the microstrip junction.

2. The radio frequency circulator of claim 1, wherein the plurality of peripheral extensions are arranged at regular intervals about the microstrip junction.

3. The radio frequency circulator of claim 1, wherein the microstrip junction defines at least one axis of symmetry between the two of the plurality of ports.

4. The radio frequency circulator of claim 3, wherein the plurality of peripheral extensions each comprise a plurality of open microstrip stubs extending generally perpendicular to the at least one axis of symmetry.

5. The radio frequency circulator of claim 4, wherein the plurality of open microstrip stubs comprises a plurality of first open microstrip stubs that are parallel to one another and extend in a first direction and a plurality of second open microstrip stubs that are parallel to one another and extend in a second direction that is opposite to the first direction, wherein the first direction and the second direction are both generally perpendicular to the at least one axis of symmetry between the plurality of ports.

6. The radio frequency circulator of claim 1, wherein a width of the at least one channel is smaller than a width of the plurality of open microstrip stubs.

7. The radio frequency circulator of claim 1, wherein the microstrip junction comprises a triangle-shaped Y-junction.

8. The radio frequency circulator of claim 7, where the plurality of peripheral extensions comprises three peripheral extensions, the three peripheral extensions arranged at regular intervals at an angular spacing of about 120° about the triangle-shaped Y-junction.

9. The radio frequency circulator of claim 1, further comprising a ground plane disposed on the second surface of the substrate.

10. The radio frequency circulator of claim 1, further comprising a permanent magnet mounted on the first surface of the substrate coaxially with a center of the microstrip junction.

11. The radio frequency circulator of claim 10, further comprising a dielectric spacer disposed between the microstrip junction and the permanent magnet.

12. A radio frequency communication device, the radio frequency communication device comprising at least one radio frequency circulator, the at least one radio frequency circulator comprising:
a substrate, the substrate comprising a ferrite material, the substrate having a first surface and a second surface, the second surface opposing the first surface;
a patterned conductive layer disposed on the first surface of the substrate, the patterned conductive layer comprising a plurality of ports coupled to a resonator structure, the resonator structure comprising:
a plurality of peripheral extensions coupled to a microstrip junction, each peripheral extension comprising a plurality of open microstrip stubs and at least one channel connecting the plurality of open microstrip stubs, the plurality of peripheral extensions arranged at regular intervals about the microstrip junction.

13. The radio frequency communication device of claim 12, wherein the microstrip junction defines at least one axis of symmetry between two of the plurality of ports, wherein the plurality of open microstrip stubs comprises a plurality of first open microstrip stubs extending in a first direction and a plurality of second open microstrip stubs extending in a second direction that is opposite to the first direction, wherein the first direction and the second direction are both generally perpendicular to the at least one axis of symmetry between the plurality of ports.

14. The radio frequency communication device of claim 12, wherein a width of the at least one channel is smaller than a width of the plurality of open microstrip stubs.

15. The radio frequency communication device of claim 12, wherein the microstrip junction comprises a triangle-shaped Y-junction, wherein the plurality of peripheral extensions comprises three peripheral extensions each of the three peripheral extensions arranged at regular intervals at an angular spacing of about 120° about the triangle-shaped Y-junction.

16. The radio frequency communication device of claim 12, further comprising a ground plane disposed on the second surface of the radio frequency circulator and a permanent magnet mounted on the first surface of the radio frequency circulator.

17. A three-port radio frequency circulator, comprising:
a substrate comprising a ferrite material, the substrate having a first surface and a second surface;
a patterned conductive layer disposed on the first surface;
a ground plane disposed on the second surface;
the patterned conductive layer comprising:
a first port;
a second port;
a third port;
a resonator structure, the resonator structure comprising: a triangle-shaped Y-junction coupled to the first port, the second port, and the third port;
a first peripheral extension comprising a plurality of open microstrip stubs and at least one channel connecting the plurality of open microstrip stubs, each of the plurality of open microstrip stubs extending generally perpendicular to a first axis of symmetry defined between the first port and the second port;
a second peripheral extension comprising a plurality of open microstrip stubs and at least one channel connecting the plurality of open microstrip stubs, each of the plurality of open microstrip stubs extending generally perpendicular to a first axis of symmetry defined between the second port and the third port;
a third peripheral extension comprising a plurality of open microstrip stubs and at least one channel connecting the plurality of open microstrip stubs, each of the plurality of open microstrip stubs extending generally perpendicular to a first axis of symmetry defined between the third port and the first port; and
a first microstrip line extending from the first port to the triangle-shaped Y-junction;
a second microstrip line extending from the second port to the triangle-shaped Y-junction; and
a third microstrip line extending from the third port to the triangle-shaped Y-junction; wherein the first microstrip line, the second microstrip line, and the third microstrip line are arranged at regular intervals about the Y-junction at an angular spacing of about 120°.
a permanent magnet mounted to the first surface of the substrate such that a center of the permanent magnet is disposed over the triangle-shaped Y-junction.

18. The three-port radio frequency circulator of claim 17, wherein the patterned conductive layer comprises a first matching circuit disposed between the first port and the triangle-shaped Y-junction, a second matching circuit disposed between the second port and the triangle-shaped Y-junction, and a third matching circuit disposed between the third port and the triangle-shaped Y-junction.

19. The three-port radio frequency circulator of claim 18, wherein the first matching circuit, the second matching circuit, and third matching circuit each comprise at least one open capacitive stub and at least one slot capacitance.

20. The three-port radio frequency circulator of claim 17, further comprising a first soldering pad coupled to the first port, a second soldering pad coupled to the second port, and a third soldering pad coupled to the third port.
